(19) United States
(12) Patent Application Publication
(10) Pub. No.: US 2006/0236000 A1
(43) Pub. Date: Oct. 19, 2006

(54) Method and system of split-streaming direct memory access

(76) Inventors: John Thomas Falkowski, White Haven, PA (US); Bruce Godley Littlefield, Oley, PA (US); Hussein K. Mecklai, Breinigsville, PA (US); Stanley Reinhold, Breinigsville, PA (US)

Correspondence Address: William S. Francos;VOLENTINE FRANCOS & WHITT, PLLC., One Freedom Square, Suite 1260, 11951 Freedom Drive, Reston, VA, 20190, US

(21) Appl. No.: 11/106,814

(22) Filed: Apr. 15, 2005

(51) Int. Cl. G06F 13/28

(52) U.S. Cl. 710/22

(57) ABSTRACT

A method and system of split-streaming direct memory access (DMA) data transfer can transfer N words of data from a source device to two different sets of memory locations using only N data read cycles and 2N data write cycles. In a single data word transfer mode, a data read operation on the memory bus is followed by two consecutive data write cycles wherein the same data is written to two different memory addresses. In a data burst mode, a data burst read operation is followed by a series of paired data write cycles, wherein in each pair of data write cycles, one of the data words is written to two different memory addresses.

### BACKGROUND AND SUMMARY

1. Field

This invention pertains to the field of data transfer using a memory bus, and more particularly, to a system and method of transferring data over a memory bus to more than two memory locations using direct memory access.

2. Description

Direct memory access (DMA) systems are well-known. For example, in a personal computer associated with a number of different input/output (I/O) devices, DMA is a way of facilitating high speed data transfer between an I/O device and the computer's main memory (e.g., random access memory (RAM)) without requiring the aid of the main processor. This allows the main processor to perform other operations (e.g., using the processor's cache) while an I/O device transfers data to or from the main memory over the system's memory bus. Generally, the DMA process is handled by a DMA controller which is typically a primitive secondary processor dedicated to the job of relieving the main processor of the burden of memory transfers between memory and I/O devices. The DMA controller has a number of DMA channels for transferring data between devices and memory locations connected to the system's memory bus. When a DMA data transfer is to be performed, the DMA controller takes control of the memory bus, reading data from a source device or main memory, and then writing the data to main memory, or a source device, depending upon the particular data transfer operation.

FIG. 1 shows an exemplary DMA data transfer operation.

In an initial step 105, either a device sends a DMA request to the DMA controller, or software executed by the main processor instructs the DMA controller to initiate a DMA data transfer.

In a subsequent step 110, after all pending processor operations on the memory bus are complete, the DMA controller asserts a line (e.g., a Hold Acknowledge line) to gain control of the memory bus and lock out the main processor.

In a next step 115, the DMA controller sets up the memory bus for a data read operation, for example by asserting a Read/Write_Bar line (the line is set to Read). At this time, the read address from which the data is to be read is set on the address lines of the memory bus. The address may correspond to an address in the main memory, or an address associated with a device from which the data is to be read.

In a step 120, in response to the Read command on the Read/Write_Bar line and the read address on the address lines, the data to be read is latched onto the data lines, by the main memory, or the source device, depending upon the particular data transfer operation.

Then, in a step 125, the DMA controller sets up the memory bus for a data write operation, for example by deasserting a Read/Write_Bar line (the line is reset to Write). At this time, the write address to which the data is to be written is set on the address lines of the memory bus. The write address may correspond to an address in the main memory, or an address associated with a device to which the data is to be written.

In a next step 130, in response to the Write command on the Read/Write_Bar line and the address on the address lines, the data that was latched onto the data lines during the immediately previous data read step 120, is written to the main memory, or the source device, depending upon the particular data transfer operation.

When multiple words of data are to be transferred, the steps 115-130 may be repeated until all of the data has been transferred.

Unfortunately, for many systems and applications, the process described above is inefficient and time-consuming.

An example will be explained with respect to FIG. 2, which is a functional block diagram of a portable image processing device 200. In particular, the portable image processing device 200 may be a portable digital video camcorder, or, more generally, any portable data processing device including a video camcorder function (e.g., a mobile telephone with a built-in camcorder). In the example to follow, it is assumed that the portable image processing device 200 is a portable digital video camcorder which may be a standalone unit, or part of a device including other functions (e.g., mobile phone, personal digital assistant (PDA), etc.).

The image processing device 200 includes an image capture device 210, a display 220, a main processor 230, main memory 240, and a long term data storage device 250. The image capture device 210, a display 220, a main processor 230, main memory 240 all transfer data via a main memory bus (not shown) under control of a DMA controller (also not shown).

In one embodiment, the image capture device 210 may include a charge-coupled device. The image capture device 210 also may include an internal memory buffer for temporarily storing the captured image data and transferring the image data to other portions of the image processing device 200. The display 220 may be a liquid crystal display (LCD) device and may have a dedicated display/video memory. Alternatively, the display/video memory for the display 220 may be a shared portion of the main memory 240. The display 220 may operate under control of the main processor 230, or, alternatively, may operate under control of a dedicated video processor (not shown). The main processor 230 performs operations using main memory 240, but it also may have a dedicated processor cache. The long term data storage device 250 may include an EEPROM, flash memory, micro-hard disk drive, or other form of programmable nonvolatile data storage. Beneficially, the long term data storage device 250 includes a removable data storage unit. For example, the long term data storage device 250 may be in the format of a standard memory card or device, such as Universal Serial Bus (USB) flash memory, Compact Flash card, Smart Media card, Secure Digital card, or any other convenient format.

In operation, the image capture device 210 captures video images, for example as video frames. The display 220 functions as a video monitor for the camcorder, and displays the video captured by the image capture device 210 in (near) real-time. Meanwhile, the main processor 230 performs a video compression algorithm on the captured video to reduce the amount of memory required to store the video. Beneficially, the video compression algorithm may be a standard algorithm such a motion picture encoding group (MPEG) encoding. Compressed video may then be stored on the long term storage device 250 such that, for example, the video may be subsequently transferred to a personal computer, or archived on a digital versatile disk (DVD), etc.

During the above-referenced operations, video data is repeatedly transferred by DMA from the image capture device 210 to two different locations: the display or video memory, and the processor cache or portion of main memory 240 that the processor 230 uses to temporarily store raw video data while it performs its video compression algorithm.

According to the operation of the DMA controller as explained above with respect to FIG. 1, this requires a first DMA operation using a first DMA channel performing a data read operation from the image capture device 210, followed by a first data write operation to the display or video memory, which may be defined by certain addresses in the main memory 240. Additionally, this requires a second DMA operation using a second DMA channel performing a second data read operation from the image capture device 210, followed by a second data write operation to the processor cache or portion of main memory 240 that the processor 230 uses to temporarily store raw video data while it performs its video compression algorithm.

Accordingly, to transfer N words of data from a source device to two different memory locations, requires 2N data read cycles and 2N data write cycles, not counting overhead for the DMA channels.

This is undesirably inefficient and time consuming, requires at least four operations and many bus cycles. This can create a significant bottleneck in the system, requiring either over-designed system components to achieve the required speed, or reduced capability.

Accordingly, it would be advantageous to provide an improved method of DMA data transfer which can more efficiently transfer data to two or more different locations associated with a memory bus using fewer bus cycles. It would also be advantageous to provide a data processing system which can more efficiently transfer one set of data to two or more different locations associated with a memory bus using fewer bus cycles. Other and further objects and advantages will appear hereinafter.

The present invention comprises a system and method of transferring data over a memory bus to two or more memory locations using direct memory access.

In one aspect of the invention, a method of transferring data comprises: executing a direct memory access (DMA) read operation on a memory bus to read data from a source device during a DMA read cycle; executing a first DMA write operation on the memory bus to write the data to a first memory location identified by a first memory address, during a first DMA write cycle; and executing a second DMA write operation on the memory bus to write the data to a second memory location identified by a second memory address, during a second DMA write cycle immediately subsequent to the first DMA write cycle.

In another aspect of the invention, a method of transferring data comprises: executing a direct memory access (DMA) read operation on a memory bus to read a plurality of data from a source device into a register set associated with a DMA controller connected to the memory bus; and executing a DMA write operation on the memory bus to write the plurality of data from the register set to a first plurality of memory locations associated with a first set of memory addresses, and to a second plurality of memory locations associated with a second set of memory addresses.

In yet another aspect of the invention, a data processing system comprises: a memory bus for communicating data, the memory bus including a plurality of data lines and a plurality of address lines; and a direct memory access (DMA) memory controller connected to the data bus and adapted to take control of the memory bus in response to a DMA request to execute a DMA read operation on the memory bus to read data on the data bus, to execute a first DMA write operation on the memory bus to write the data to a first memory address during a first DMA write cycle, and to execute a second DMA write operation on the memory bus to write the data to a second memory address during a second DMA write cycle immediately subsequent to the first DMA write cycle

### BRIEF DESCRIPTION OF THE DRAWINGS

FIG. 1 shows an exemplary DMA data transfer operation on a memory bus;

FIG. 2 is a functional block diagram of a portable image processing device;

FIG. 3 is a functional diagram of an exemplary data processing system;

FIG. 4 shows a first embodiment of a DMA data transfer operation according to one or more aspects of the present invention;

FIG. 5 shows a second embodiment of a DMA data transfer operation according to one or more aspects of the present invention.

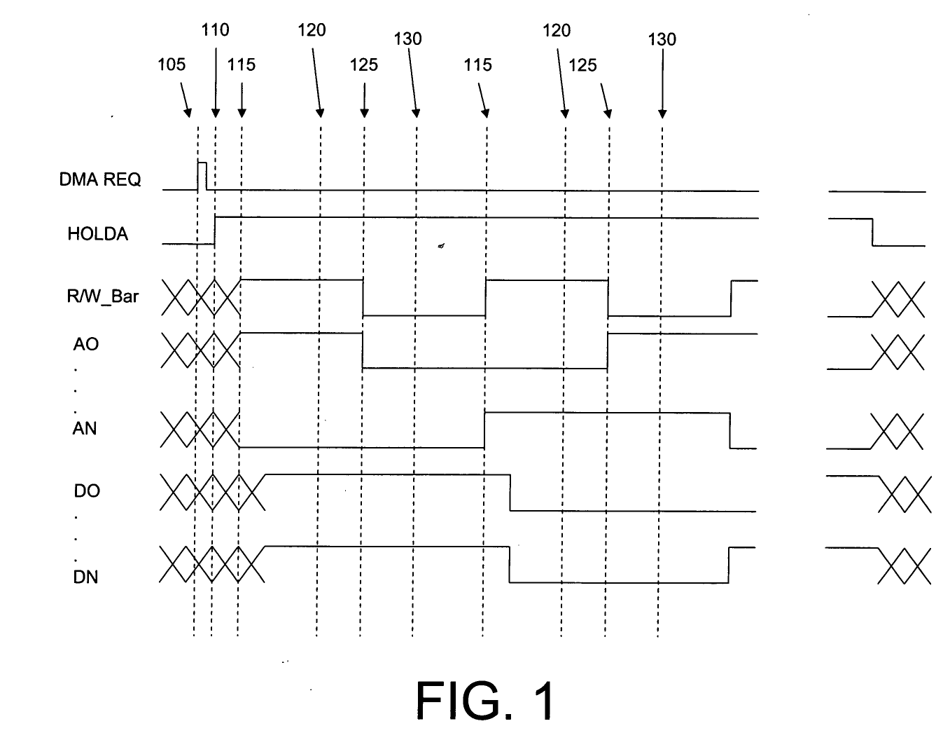

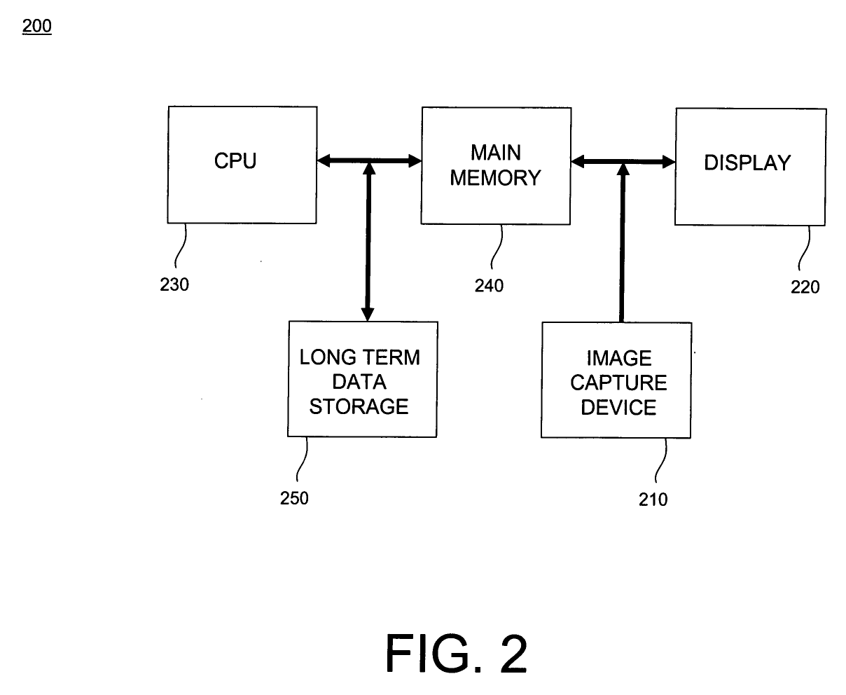

### DETAILED DESCRIPTION

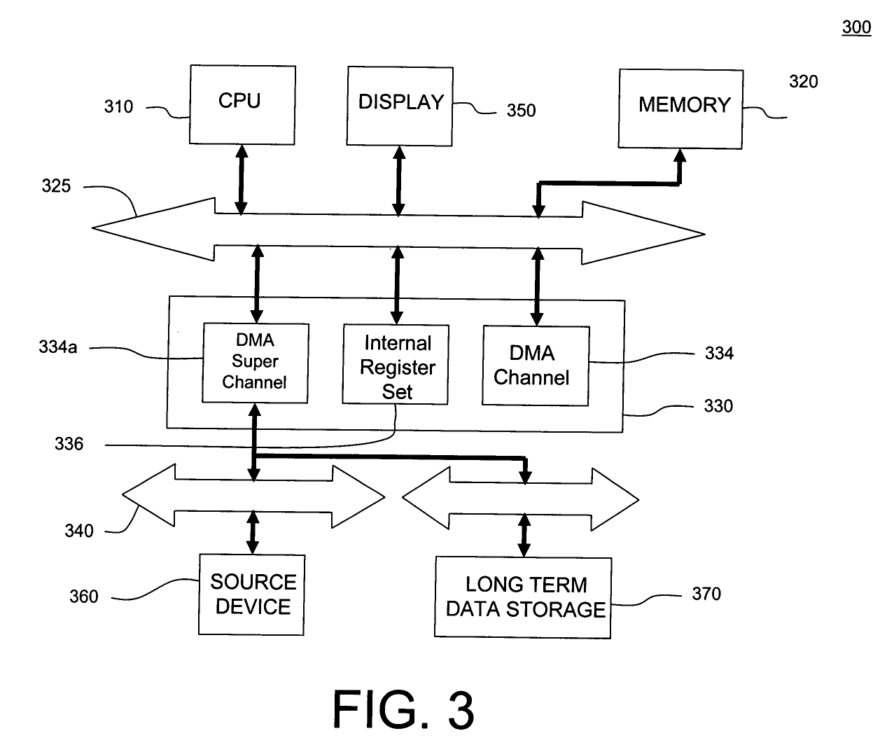

FIG. 3 is a functional diagram of an exemplary data processing system 300 for explaining certain DMA operations. In particular, the data processing system 300 may be a portable digital video camcorder, or, more generally, any portable data processing device including a video camcorder function (e.g., a mobile telephone with a built-in camcorder). In the example to follow, it is assumed that the data processing system 300 is a portable digital video camcorder which may be a standalone unit, or part of a device including other functions (e.g., mobile phone, personal digital assistant (PDA), etc.).

The system 300 includes a central (main) processor 310, a main memory 320, a memory bus 325, a DMA controller 330, a first I/O bus 340, a display 350, a source device (e.g., an image capture device) 360, a second I/O bus and long term storage device 370.

The main processor 310 performs operations using main memory 320, but it also may have a dedicated processor cache.

Typically, the main memory 320 is random access memory (RAM). Memory addresses identify particular locations in the main memory 320 where data can be stored. Beneficially, the main memory 320 may be organized into data words comprising 32 bits, although other configurations are also possible.

The memory bus 325 includes a Read/Write_Bar line, a plurality of address lines, and a plurality of data lines. Beneficially, the memory bus 325 includes 32 data lines to transfer data in units of 32-bit words.

The DMA controller 330 may include one or more DMA channels 334, including at least one DMA super-channel 334a, and an internal register set 336. Each DMA channel 334 has a dedicated DMA request line and, typically, a separate control register.

The display 350 may be a liquid crystal display (LCD) device and may have a dedicated display/video memory. Alternatively, the display/video memory for the display 350 may be a shared portion of the main memory 320. The display 350 may operate under control of the main processor 310, or, alternatively, may operate under control of a dedicated video processor (not shown).

The source device 360 resides on the first I/O bus 340 and transfers data to the memory bus 325 via a DMA super-channel 334a of the DMA controller 330, as will be explained in further detail below. In the remainder of discussion to follow to explain various principles of the system 300, it will be assumed that the source device 360 is an image capture device.

In one embodiment, the image capture device 360 may include a charge-coupled device. The image capture device 360 also may include an internal memory buffer for temporarily storing the captured image data and transferring the image data to other portions of the image processing device 200.

The long term data storage device 370 may include an EEPROM, flash memory, micro-hard disk drive, or other form of programmable nonvolatile data storage. Beneficially, the long term data storage device 370 includes a data removable storage unit. For example, the long term data storage device 370 may be in the format of a standard memory card or device, such as Universal Serial Bus (USB) flash memory, Compact Flash card, Smart Media card, Secure Digital card, or any other convenient format.

In operation, the image capture device 360 captures video images, for example, as video frames. The display 350 functions as a video monitor and displays the video captured by the image capture device 360 in (near) real-time. Meanwhile, the main processor 310 performs a video compression algorithm on the captured video to reduce the amount of memory required to store the video. Beneficially, the video compression algorithm may be standard algorithm such a motion picture encoding group (MPEG) encoding. Compressed video may then be stored on the long term storage device 370 such that, for example, the video may be subsequently transferred to a personal computer, or archived on a DVD, etc.

Accordingly, as noted above, advantageously the DMA controller 330 is adapted with a DMA super-channel 334a for transferring one set of data from the image capture device 360 to two different locations having two different addresses on the memory bus 325, as will be explained in more detail below.

The DMA controller 330 supports at least two different types of DMA transfers. Type 0 transfers are designed for transferring data between devices that reside on the main memory bus 325. Type 1 transfers are designed for transferring data between the memory bus 325 and the I/O bus 365. A Type 0 transfer makes use of the internal register set 336 to store data to be transferred. A Type 0 DMA transfer consists of two transactions: (1) reading data from a memory location on the memory bus 325 to the internal resister set 336; and (2) writing the data from the internal register set 336 to another memory location on the memory bus 325. Meanwhile, a Type 1 DMA transfer involves reading data from a memory location on memory bus 325 and writing the data to an I/O device on one of the I/O buses, or reading data from an I/O device on one of the I/O buses and writing the data to a memory location on the memory bus 325. Both burst and single data transfers are typically supported.

The DMA Controller 330 allows both hardware initiated transactions (synchronized data transfers), and software initiated transactions (unsynchronized data transfers). If a channel is set up for unsynchronized data transfer, a transaction is started, for example, by the system software setting a start bit in the channel's control register.

Meanwhile, if a channel is set up for synchronized data transfer, then a data transfer is started when a requesting device (e.g., image capture device 360) sends a DMA request signal for the channel. The DMA controller 330 then signals the processor 310 that it wants to take control of the memory bus 325, for example by a Hold Request line of the processor 310. The DMA Controller 330 waits for the processor 310 to finish its current task, then it “locks out” the processor from the memory bus 325, for example by asserting a Hold Acknowledge line of the processor 310. Then, the DMA Controller 330 takes control of the memory bus 325, signals the requesting device, for example via a DMA Acknowledgement line, that it is ready to begin data transfer, and transfers data from or to the requesting device. When the process is complete, all lines are reset, the processor is no longer “locked out,” from the memory bus 325, and the whole process is ready to begin again.

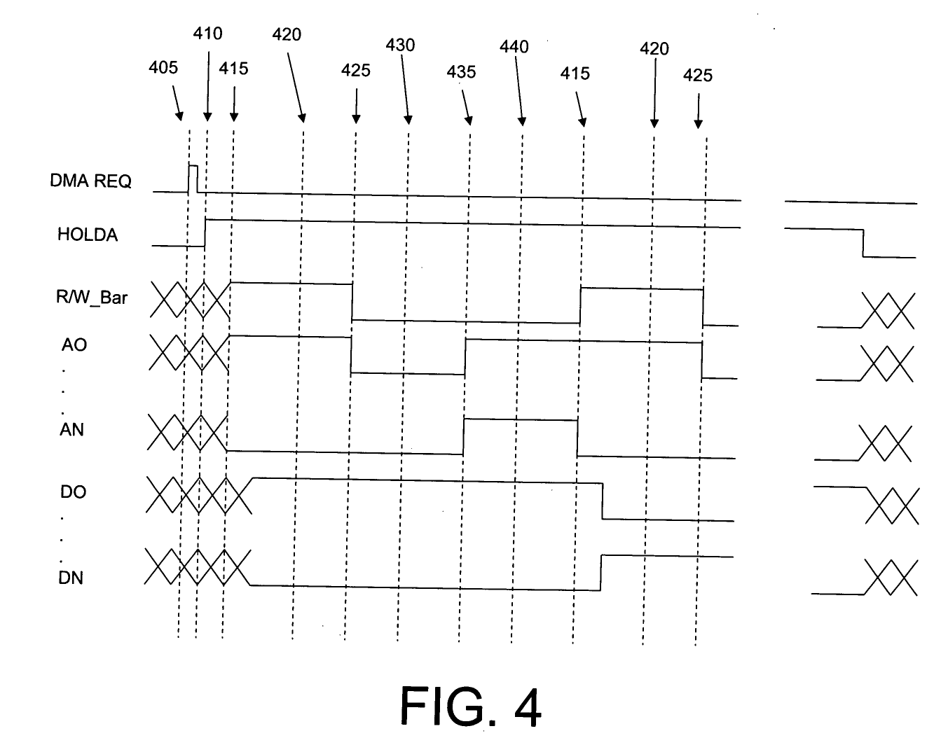

FIG. 4 shows a first embodiment of a DMA data transfer method 400 for transferring one set of data from the image capture device 360 to two different memory locations associated with the memory bus 325 using the DMA super-channel 334a of the DMA controller 330. It is understood in the description to follow that the various operations in the method 400 normally occur in response to a memory bus clock signal (not shown), for example, in response to the rising edge of the clock signal.

In an initial step 405, either the image capture device 360 sends a DMA request to the DMA controller 330, or software executed by the main processor 310 instructs the DMA controller to initiate a DMA data transfer from the image capture device 360.

In a subsequent step 410, after all pending processor operations on the memory bus 325 are complete, the DMA controller 330 asserts a line (e.g., a Hold Acknowledge line) to gain control of the memory bus 325 and lock out the main processor 310.

In a next step 415, the DMA controller sets up the memory bus 325 for a data read operation, for example by asserting a Read/Write_Bar line (the line is set to Read). At this time, the read address from which the data is to be read from the image capture device 360 is set on the address lines of the memory bus 325. The read address may correspond to an address of a memory buffer associated with the image capture device 360 from which the data is to be read.

In a step 420, in response to the Read command on the Read/Write_Bar line and the read address on the address lines, the data to be read from the image capture device 360 is latched onto the data lines of the memory bus 325. Alternatively, the data could be latched into the internal register set 336 of the DMA controller 330 during the data read cycle, and then this latched data can be used as the source of the data to be written in the subsequent steps 425-435 below.

Then, in a step 425, the DMA controller 330 sets up the memory bus 325 for a first data write operation, for example by deasserting a Read/Write_Bar line (the line is reset to Write). At this time, the first write address to which the data is to be written is set on the address lines of the memory bus 325. The first write address may correspond to an address in the main memory 320 to which the data is to be written. In one example, the first write address may identify a display/video memory location where video data is stored to be displayed on the display 350. This may be an address in a dedicated display/video memory, or an address in the main memory 320. Alternatively, the first write address may identify a memory location where raw video data is stored for the processor 310 to perform its video compression algorithm. This may be an address in a processor cache, or an address in the main memory 320.

In a next step 430, in response to the Write command on the Read/Write_Bar line and the first write address on the address lines, the data that was latched onto the data lines during the immediately previous data read step 420, is written to the memory location identified by the first write address.

Next, in an immediately subsequent step 435, the DMA controller 330 sets up the memory bus 325 for a second data write operation. The Read/Write_Bar line remains deasserted to implement another Write command, and the data on the data lines remain unchanged. The second write address to which the data is to be written is set on the address lines of the memory bus 325. The second write address may correspond to an address in the main memory 320 to which the data is to be written. In one example, the second write address may identify a memory location where raw video data is stored for the processor 310 to perform its video compression algorithm. This may be an address in a processor cache, or an address in the main memory 320. Alternatively, the second write address may identify a display/video memory location where video data is stored to be displayed on the display 350. This may be an address in a dedicated display/video memory, or an address in the main memory 320.

In a next step 440, in response to the Write command on the Read/Write_Bar line and the second write address on the address lines, the data that was latched onto the data lines during the previous data read step 420, is written to the memory location identified by the second write address.

During the first and second DMA write operations in steps 425-440, the data that was latched onto the data lines during the immediately previous data read step 420 remains latched onto the data lines.

When multiple words of data are to be transferred, the steps 415-440 are repeated until all of the data has been transferred.

In summary, according to the DMA data transfer method 400, data is read once and written twice. A data read operation is followed by a data write operation using the same data. On the read cycle, data is latched from the source device onto the data lines of the memory bus. The data read cycle is followed by two consecutive data write cycles which have different addresses on the address lines of the memory bus, but with the same data on the data lines. That is, the write address on the address lines is changed between the first and second data write cycles, but the data on the data lines is not changed. Accordingly, N words of data can be transferred from a source device to two different sets of memory locations using only N data read cycles and 2N data write cycles.

The DMA data transfer method 400 reads and writes data one data word (e.g., 32 bits) at a time.

However, the principles can be extended to entire data sets instead of a single data word. By using the internal register set 336 of the DMA Controller 330, in conjunction with a start read address, an end read address, a pair of start write addresses and a pair of end write addresses, a desired number of data words first could be read from the source device into the register set 316 during a read data burst, and then the data words could be written from the register set 316 to the first and second sets of memory locations (or first and second memory devices) with a series of paired write cycles.

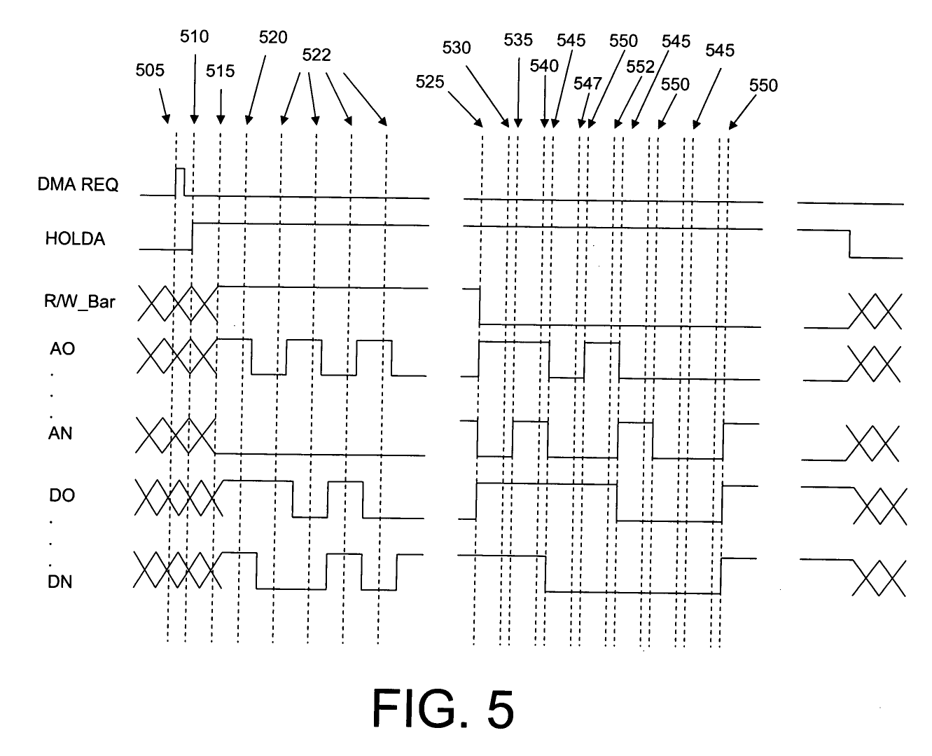

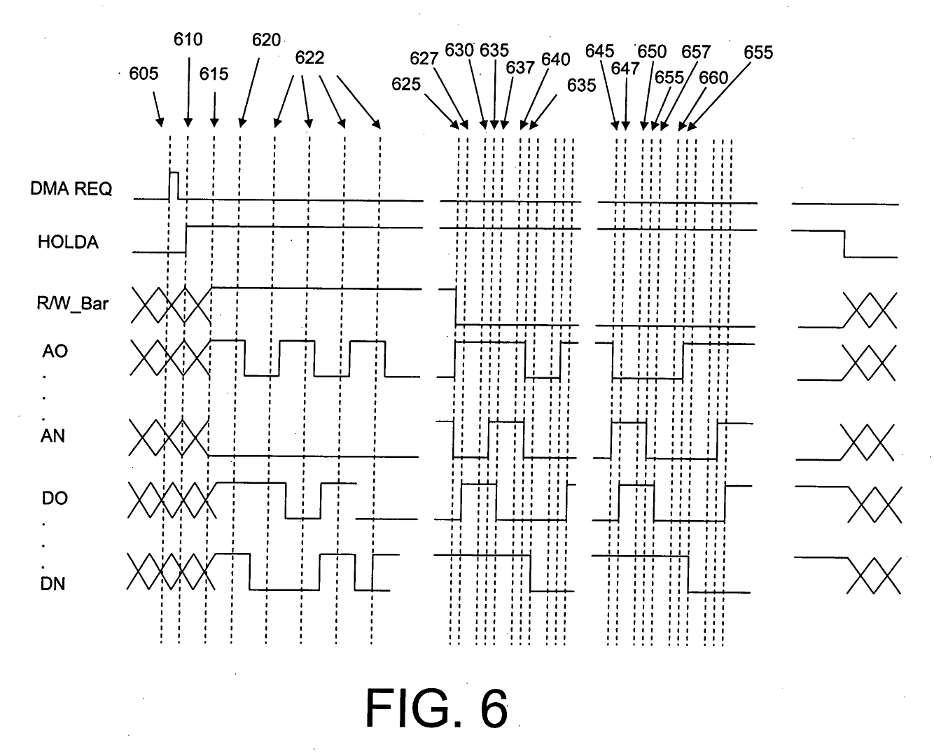

FIG. 5 shows a second embodiment of a DMA data transfer method 500 for transferring a set of data from the image capture device 360 to two different sets of memory locations associated with the memory bus 325 using the DMA super-channel 334a of the DMA controller 330. It is understood in the description to follow that the various operations in the method 500 normally occur in response to a memory bus clock signal (not shown), for example, in response to the rising edge of the clock signal.

In an initial step 505, either the image capture device 360 sends a DMA request to the DMA controller 330, or software executed by the main processor 310 instructs the DMA controller to initiate a DMA data transfer from the image capture device 360.

In a subsequent step 510, after all pending processor operations on the memory bus 325 are complete, the DMA controller 330 asserts a line (e.g., a Hold Acknowledge line) to gain control of the memory bus 325 and lock out the main processor 310.

In a next step 515, the DMA controller sets up the memory bus 325 for a read data burst operation, for example by asserting a Read/Write_Bar line (set to Read). At this time, the start read address from which the first data word is to be read from the image capture device 360 is set on the address lines of the memory bus 325. The start read address may correspond to an address of a memory buffer associated with the image capture device 360 from which the data is to be read.

In a step 520, in response to the Read command on the Read/Write_Bar line and the start read address on the address lines, the first word of data to be read from the image capture device 360 is latched into a first location in the internal register set 336 of the DMA controller 330.

In a next step 522, the read address is incremented on the address lines, and the next word of data to be read from the image capture device 360 is latched into the next location in the internal register set 336 of the DMA controller 330.

Step 522 is repeated until all of the data words to be read from the image capture device 360 are read into the internal register set 316, that is, until the read address on the address lines corresponds to the end read address.

Meanwhile, the Read/Write_Bar line remains asserted (the line is set to Read) for all of the read cycles comprising the read data burst operation of steps 515-522.

Then, in a step 525, the DMA controller 330 sets up the memory bus 325 for a first data write operation, for example by deasserting a Read/Write_Bar line (the line is reset to Write). Also, at this time, the first start write address to which the first word of data is to be written is set on the address lines of the memory bus 325. The first start write address may correspond to an address in the main memory 320 to which the first data word is to be written. In one example, the first start write memory address may identify a display/video memory location where video data is stored to be displayed on the display 350. This may be an address in a dedicated display/video memory, or an address in the main memory 320. Alternatively, the first start write address may identify a memory location where raw video data is stored for the processor 310 to perform its video compression algorithm. This may be an address in a processor cache, or an address in the main memory 320. The first data word from the internal register set 336 is also placed on the data lines of the memory bus 325.

In a next step 530, in response to the Write command on the Read/Write_Bar line and the first start write address on the address lines, the first data word from the internal register set 336 is written to the memory location identified by the first start write address.

Next, in an immediately subsequent step 535, the DMA controller 330 sets up the memory bus 325 for a second data write operation. The Read/Write_Bar line remains deasserted to implement another Write command, and the first data word on the data lines remain unchanged. The second start write address to which the first data word is to be written is set on the address lines of the memory bus 325. The second start write address may correspond to an address in the main memory 320 to which the first data word is to be written. In one example, the second start write address may identify a memory location where raw video data is stored for the processor 310 to perform its video compression algorithm. This may be an address in a processor cache, or an address in the main memory 320. Alternatively, the second start write address may identify a display/video memory location where video data is stored to be displayed on the display 350. This may be an address in a dedicated display/video memory, or an address in the main memory 320.

In a next step 540, in response to the Write command on the Read/Write_Bar line and the second start write address on the address lines, the first data word from the internal register set 336 is written to the memory location identified by the second start write address.

During the first and second DMA write operations in steps 525-540, the same data word remains latched onto the data lines.

In a next step 545, the first write address is incremented and placed on the address lines, while the Read/Write_Bar line remains deasserted to implement another Write command. The next data word from the internal register set 336 is also placed on the data lines. In response to the Write command on the Read/Write_Bar line and the first write address on the address lines, in step 547 the next data word from the internal register set 336 is written to the memory location identified by the first write address.

In an immediately subsequent step 550, the second write address is incremented and placed on the address lines, while the Read/Write_Bar line remains deasserted to implement another Write command and the data word on the data lines remains unchanged. In response to the Write command on the Read/Write_Bar line and the second write address on the address lines, in a step 552 the data word on the data lines of the memory bus 325 is written to the memory location identified with the second write address.

During the steps 545-552, the same data word remains latched onto the data lines.

Steps 545-552 are repeated until all of the data words from the internal register set 336 are written to the first and second sets of memory locations, that is, until the write addresses on the address lines correspond to the first and second end write addresses.

In summary, according to the DMA data transfer method 500, a group of data is read once in a read data burst comprising a plurality of consecutive data read cycles. The read data burst is followed by a series of paired data write cycles which have different addresses on the address lines of the memory bus, but with the same data on the data lines. That is, the write address on the address lines is changed between the first and second data write cycles of each pair of data write cycles, but the data on the data lines is not changed. Meanwhile, the data on the data lines is changed between each pair of data write cycles. Accordingly, N words of data can be transferred from a source device to two different sets of memory locations using only N data read cycles and 2N data write cycles.

FIG. 6 shows a third embodiment of a DMA data transfer method 600 for transferring a set of data from the image capture device 360 to two different sets of memory locations associated with the memory bus 325 using the DMA super-channel 334a of the DMA controller 330. The data transfer method 600 operates in a data burst transfer mode, in similarity to the data transfer method 500 of FIG. 5. As in the method 500, in the method 600 of FIG. 6, a desired number of data words are first read from the source device into the register set 316 during a read data burst. However, in contrast to the method 500 in which the data words are written to the first and second sets of memory locations with a series of paired write cycles, in the method 600, the data words are written to the first and second sets of memory locations (or first and second devices) in two bursts, first writing all of the data to the first set of memory locations (or first device), and then writing all of the data to the second set of memory locations (or second device). It is understood in the description to follow that the various operations in the method 600 normally occur in response to a memory bus clock signal (not shown), for example, in response to the rising edge of the clock signal.

In an initial step 605, either the image capture device 360 sends a DMA request to the DMA controller 330, or software executed by the main processor 310 instructs the DMA controller to initiate a DMA data transfer from the image capture device 360.

In a subsequent step 610, after all pending processor operations on the memory bus 325 are complete, the DMA controller 330 asserts a line (e.g., a Hold Acknowledge line) to gain control of the memory bus 325 and lock out the main processor 310.

In a next step 615, the DMA controller sets up the memory bus 325 for a read data burst operation, for example by asserting a Read/Write_Bar line (set to Read). At this time, the start read address from which the first data word is to be read from the image capture device 360 is set on the address lines of the memory bus 325. The start read address may correspond to an address of a memory buffer associated with the image capture device 360 from which the data is to be read.

In a step 620, in response to the Read command on the Read/Write_Bar line and the start read address on the address lines, the first word of data to be read from the image capture device 360 is latched into a first location in the internal register set 336 of the DMA controller 330.

In a next step 622, the read address is incremented on the address lines, and the next word of data to be read from the image capture device 360 is latched into the next location in the internal register set 336 of the DMA controller 330.

Step 622 is repeated until all of the data words to be read from the image capture device 360 are read into the internal register set 316, that is, until the read address on the address lines corresponds to the end read address.

Meanwhile, the Read/Write_Bar line remains asserted (the line is set to Read) for all of the read cycles comprising the read data burst operation of steps 615-622.

Then, in a step 625, the DMA controller 330 sets up the memory bus 325 for a first data write operation for example by deasserting a Read/Write Bar line (the line is reset to Write). Also, at this time, the first start write address to which the first word of data is to be written is set on the address lines of the memory bus 325. The first start write address may correspond to an address in the main memory 320 to which the first data word is to be written. In one example, the first start write memory address may identify a display/video memory location where video data is stored to be displayed on the display 350. This may be an address in a dedicated display/video memory, or an address in the main memory 320. Alternatively, the first start write address may identify a memory location where raw video data is stored for the processor 310 to perform its video compression algorithm. This may be an address in a processor cache, or an address in the main memory 320.

Next, in a step 627, the first data word from the internal register set 336 is placed on the data lines of the memory bus 325.

In a next step 630, in response to the Write command on the Read/Write_Bar line and the first start write address on the address lines, the first data word from the internal register set 336 is written to the memory location identified with the first start write address.

Then, in a step 635, the first write address is incremented and placed on the address lines while the Read/Write_Bar line remains deasserted.

Next, in a step 637, the next data word from the internal register set 336 is placed on the data lines of the memory bus 325.

In response to the Write command on the Read/Write_Bar line and the first write address on the address lines, in a step 640, the next data word from the internal register set 336 is written to the memory location identified with the next first write address.

Steps 635-640 are repeated until all of the data words from the internal register set 336 are written to the first set of memory locations, that is, until the write address on the address lines corresponds to the first end write address.

After writing all of the data in a burst mode to the first set of memory locations, in a step 645, the DMA controller 330 sets up the memory bus 325 for a second data write operation. The Read/Write_Bar line remains deasserted to implement another Write command. The second start write address to which the first data word is to be written is set on the address lines of the memory bus 325. The second start write address may correspond to an address in the main memory 320 to which the first data word is to be written. In one example, the second start write address may identify a memory location where raw video data is stored for the processor 310 to perform its video compression algorithm. This may be an address in a processor cache, or an address in the main memory 320. Alternatively, the second start write address may identify a display/video memory location where video data is stored to be displayed on the display 350. This may be an address in a dedicated display/video memory, or an address in the main memory 320.

Next, in a step 647, the first data word from the internal register set 336 is placed on the data lines of the memory bus 325.

In a next step 650, in response to the Write command on the Read/Write_Bar line and the second start write address on the address lines, the first data word from the internal register set 336 is written to the memory location identified with the second start write address.

Then, in a step 655, the second write address is incremented and placed on the address lines while the Read/Write_Bar line remains deasserted.

Next, in a step 657, the next data word from the internal register set 336 is placed on the data lines of the memory bus 325.

We claim:

1. A method of transferring data, comprising:
executing a direct memory access (DMA) read operation on a memory bus to read data from a source device during a DMA read cycle;
executing a first DMA write operation on the memory bus to write the data to a first memory location identified by a first memory address, during a first DMA write cycle; and
executing a second DMA write operation on the memory bus to write the data to a second memory location identified by a second memory address, during a second DMA write cycle immediately subsequent to the first DMA write cycle.

2. The method of claim 1, wherein the first memory address corresponds to an address in a display buffer for a display, and the second memory address corresponds to an address in a processor memory for a processor to perform video compression on the data.

3. The method of claim 1, wherein executing a direct memory access (DMA) read operation to read data from the source device during a DMA read cycle comprises sending a DMA request from the source device to a DMA controller connected to the memory bus indicating a transfer of the same data to more than one location.

4. The method of claim 3, wherein the DMA request indicates a DMA channel assigned to transfer the same data to more than one location.

5. The method of claim 1, wherein executing the DMA read operation on the memory bus includes latching the data from the source device onto data lines of the memory bus, and wherein the same data remains latched on the data lines during the first and second DMA write cycles.

6. The method of claim 5, wherein executing the first and second DMA write operations includes changing the address on address lines of the memory bus between the first and second DMA write operations.

7. The method of claim 1, wherein the DMA read operation on the memory bus includes latching the data from the source device into a register associated with a DMA controller connected to the memory bus.

8. The method of claim 1, wherein the first DMA write cycle is immediately subsequent to the DMA read cycle.

9. A method of transferring data, comprising:
executing a direct memory access (DMA) read operation on a memory bus to read a plurality of data from a source device into a register set associated with a DMA controller connected to the memory bus; and
executing a DMA write operation on the memory bus to write the plurality of data from the register set to a first plurality of memory locations associated with a first set of memory addresses, and to a second plurality of memory locations associated with a second set of memory addresses.

10. The method of claim 9, wherein executing the DMA write operation comprises:
(1) writing a data word of the plurality of data stored in the register set to one of the first plurality of memory locations during a first DMA write cycle;
(2) writing the data word to one of the second plurality of memory locations during a second DMA write cycle immediately following the first DMA write cycle; and
(3) repeating steps (1) and (2) for all of the plurality of data in the register set.

11. The method of claim 10, where step (1) includes latching the data word onto data lines of the memory bus, and setting address lines of the data bus to one of the first set of addresses, identifying the one of the first plurality of memory locations to which the data word is written.

12. The method of claim 11, where step (2) includes leaving the data word latched onto the data lines of the memory bus, and setting the address lines of the data bus to one of the second set of addresses, identifying the one of the second plurality of memory locations to which the data word is written.

13. The method of claim 9, further comprising communicating to the memory controller one set of read addresses identifying where the plurality of data is to be read from the source device, and two sets of write addresses identifying where the data is to be written.

14. The method of claim 13, wherein the DMA controller decodes the two sets of write addresses to obtain the first set of addresses for memory locations in a display buffer where the data is to be written for display for a display device, and the second set of addresses in a processor memory where the data is to be written for a processor to perform video compression on the data.

15. The method of claim 9, wherein executing the DMA write operation comprises:
(1) writing all of the plurality of data stored in the register set to the first plurality of memory locations during a first write data burst; and
(2) all of the plurality of data stored in the register set to the second plurality of memory locations during a second write data burst.

16. A data processing system, comprising:
a memory bus for communicating data, the memory bus including a plurality of data lines and a plurality of address lines; and
a direct memory access (DMA) memory controller connected to the data bus and adapted to take control of the memory bus to execute a DMA read operation on the memory bus to read data on the data bus, to execute a first DMA write operation on the memory bus to write the data to a first memory location associated with a first memory address during a first DMA write cycle, and to execute a second DMA write operation on the memory bus to write the data to a second memory location associated with a second memory address during a second DMA write cycle immediately subsequent to the first DMA write cycle.

17. The system of claim 16, further comprising a source device connected to the memory bus and adapted to send a DMA request to the DMA controller.

18. The system of claim 17, further comprising a register set associated with the DMA controller adapted to temporarily store data read from the source device.

19. The system of claim 16, wherein the source device is an image capture device and the data is image data, and further comprising:
a display for displaying the image data;
a display memory for the display device, corresponding to the first memory address;
a processor adapted to compress the image data; and
a processor memory adapted to store the image data for compression by the processor, the processor memory corresponding to the second memory address.

20. The system of claim 16, wherein the DMA controller is adapted to set the address lines to the first memory address during the first DMA write cycle, and to set the address lines to a second memory address during the second DMA write cycle, while the data is latched on the data bus for both the first and second DMA write cycles.

21. A data processing system, comprising:
a memory bus for communicating data, the memory bus including a plurality of data lines and a plurality of address lines; and
a direct memory access (DMA) memory controller connected to the data bus and adapted to take control of the memory bus to execute a DMA read operation on the memory bus to read data on the data bus, to execute a first DMA write operation on the memory bus to write the data to a first plurality of memory locations associated with a first set of memory addresses during a first plurality of consecutive DMA write cycles, and to execute a second DMA write operation on the memory bus to write the data to a second plurality of memory locations associated with a second plurality of memory addresses during a second plurality of consecutive DMA write cycles, where the second plurality of consecutive second DMA write cycles is immediately subsequent to the first plurality of consecutive DMA write cycles.
